(19) United States
(12) Patent Application Publication
(10) Pub. No.: US 2005/0231330 A1
(43) Pub. Date: Oct. 20, 2005

(54) Direct contactless communication between transponders

(75) Inventors: Steffen Drews, Hamburg (DE); Karl-Ragmar Riemschneider, Hamburg (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/514,525

(22) PCT Filed: May 9, 2003
(86) PCT No.: PCT/IB03/01933

§ 371 Date: Nov. 13, 2004

(30) Foreign Application Priority Data
May 15, 2002 (DE) 102 21 451.4

(51) Int. Cl. H04Q 5/22

(52) U.S. Cl. 340/10.51; 340/10.34; 29/593

(57) ABSTRACT

In a method and a device for the communication of microelectronically integrated data carriers, which contain contactless communications devices, at least two data carriers are brought into the reciprocal range of their contactless communications devices, at least one component (field generator) generates an alternating electromagnetic field, by means of which the data carriers are supplied with sufficient energy for the internal processing and communications operations, and data can be transmitted directly from at least one of the data carriers to at least one other data carrier.

The invention relates to methods and devices for communication between microelectronically integrated data carriers, which contain contactless communications devices. These include, in particular, transponders and contactless smart cards.

There are many different types of transponder systems in use. A wide variety of applications are known, examples of which include the contactless smart card and the electronic label. The number of transponders in service as an integral part of car keys for the immobilizer on modern motor vehicles runs into millions.

A characteristic hitherto common to transponders of various designs is that they first receive energy from an emitting terminal (also known as the base station, reader station or reader), with which they then communicate. The energy is supplied by the terminal in the form of an alternating electromagnetic field. The frequency ranges of the alternating field are generally in the order of about 100 KHz to a few GHz.

With an antenna or a coil the transponder absorbs a proportion of the energy emitted in the generation of the electromagnetic field. From the antenna voltage it generates a direct voltage and thereby supplies its electronic modules, which among other things process data and communicate back to the terminal by various methods and according to various transmission protocols.

The electronic modules of transponders are for the most part monolithically integrated on one circuit. Apart from the antenna there are very few, if any, discrete components.

Terminals for transponders are also known in various design forms. As essential modules they have antennae, a transmitter device and a receiver device and data processing devices of varying functionality and complexity. The antennae generate alternating fields, which are formed in free space. However, loop antennae are also capable of spatially configuring the transmission so that more or less homogeneous fields predominate in a transmission range.

In a spatial area around the emitting terminal the field strength is adequate. In this area, hereinafter also referred to as the working zone, sufficient energy can be absorbed to supply the transponder. In addition, the signal strength of the communications transmission received at any given time must also suffice for communication between transponder and terminal. The problem of strongly fluctuating energy radiation outputs and of the signal received in the terminal by way of transponder response is solved by suitable configuration of the modulation and the protocols. Channel separations in the frequency range are also common.

Contactless smart cards contain transponders integrated into the design of the card. The antennae are in this case often incorporated in coil form into the surface of the card. In addition, various developments of the transponder principle area also known, of which the following examples will be mentioned here:
the combinations of contact and contactless communication;
the use of different channels for data transmission in each direction;
the use of sensors, the measured values of which are relayed in the manner of transponders.

Typical transponders do not have any energy source of their own, except for energy buffer storage in the form, say, of capacitors or inductors.

DE 31 49 789 C1 describes an inductive transponder. This mentions a key part (the transponder) and a lock part (the terminal). The latter combines energy emission and reader device.

DE 37 21 822 C1 describes a transponder and a contactless smart card with the peculiarity that the antenna coil is integrated on the chip crystal. Here too, however, communication is exclusively with a fixed supply circuit—the terminal.

DE 196 523 24 A1 describes a microwave antenna for transponders. This shows the scope for generally using even higher frequency ranges for the transponder principle.

DE 199 40 561 C1 describes a terminal antenna in the form of a bar or pin, which is led though a separate hole in the smart card. An effective coupling of the terminal antenna is thereby achieved.

This patent specification also discloses two smart cards which together are fitted on to the pin and “can be operated simultaneously superimposed”. In this case, however, the communication is between the terminal and each of the smart cards respectively, not direct communication between the smart cards.

The object of the invention is to permit communication between two data carriers and thereby to open up new applications for data carriers with transponders.

In the method according to the invention this object is achieved in that:
at least two of the data carriers are brought into the reciprocal range of their contactless communications devices;
at least one component (field generator) generates an alternating electromagnetic field, by means of which the data carriers are adequately supplied with energy for the internal processing and communications operations; and
data from at least one of the data carriers are transmitted directly to at least one other data carrier.

The transponders and at least one field generator are needed in order to perform the method according to the invention. The transponders, in the usual way, have antennae, receiver and transmitter circuits and data processing devices. They have all the necessary devices and suitable parameters (frequency ranges) to communicate with one another, but they do not have any energy source of their own. Specially suited transmission methods and transmission and reception protocols are implemented, it being necessary, in particular, to ensure sensitivity to weak information-carrying signals received against the background of strong radiation emanating from the energy supply.

The field generator generates the alternating field of adequate field strength in a specific (partially) enclosed space or in a working zone in the free field. The configuration of the space or the extent of the working zone is determined by the application. The working zone must be at least large enough to accommodate two transponders, smart cards and their antennae modules. Moreover, it must be possible to absorb sufficient energy from the field for at least two transponders.

In the method according to the invention, the field-generating component may receive no data from the data carrier. The communication mode is then determined solely by the circuit arrangement selected in the data carriers and the communications programs stored there. Thus, for example, one of the data carriers introduced into the alternating field can, when energized by the field, transmit data, whilst the other only receives and stores data.

According to another embodiment of the invention the field generator may transmit information on the communications mode at the start of the communication. This information may relate, for example, to which data carrier transmits and which data carrier receives, or whether data is to be exchanged, or which data will be affected by the communication.

Even without additional information, the invention can provide for the data carriers to be energized for the reception of two-way alternate communication by the availability of energy from the alternating field. Should there be multiple data carriers in a spatial area around the field generator, of which only a certain number can take part in the communication, however, it is possible in a development of the method according to the invention for the space of the energy-supplying alternating field to be limited by mechanical means, so that only a specific number of data carriers can take part in the communication.

Further advantageous developments and further developments of the method according to the invention are specified in the dependent claims.

The object of the invention is achieved in a device for the communication of microelectronically integrated data carriers having contactless communication devices in that:
at least two of the data carriers having contactless communications devices are within communications range of one another;
at least one component is available for the generation of an alternating electromagnetic field, which supplies the data carriers with energy for processing and communications operations; and
the said field spans a sufficient spatial area of adequate field strength in which the data carriers can be supplied for the direct communication.

In this case the field-generating component has no data transmission or reception devices for communication with the data carriers.

It is quite possible within the scope of the invention, however, to design the field generator for a data transmission from and to the data carriers, which in addition to the direct communication takes place between the data carriers. This may serve, for example, to document the communication between the data carriers by means of a time stamp, locality or data on the respective field generator. Reception of data from the data carriers may serve, for example, to indicate the successful conclusion of direct communication on the field generator and/or on the transponder by means of a suitable acoustic or optical signal.

The field generator and the data carriers may transmit on different frequencies or frequency bands. Additional identification data transmitted by the field generator may be used by the data carriers to distinguish between alternating fields of different frequency generators.

For reasons of simplicity, the field-generating component may be a device inherently designed for some purpose other than direct communication of the data carriers. Thus it is quite possible for the field-generating component to be a conventional transponder terminal, the alternating field emitted from which supplies the energy for the direct communication of the data carriers, but without any data from the direct communication of the data carriers being received in the terminal.

Other developments and refinements of the device according to the invention are specified in further dependent claims.

Another purpose in a particular case may also be operation of a conventional transponder terminal. The field generator is then of identical design to conventional transponder terminals, but functionally quite distinguishable. The conventional transponder mode may operate, for example, in a chronologically discrete phase or it may be distinctly separated from the proposed solution by protocols, transmission modes and the like.

Just as there are already smart cards with dual interface, with contacts and transponder communication, cards are also possible, which combine communication according to the invention and the conventional communication with contactless terminals and/or communication via contacts. These combinations, in suitably adapted form, are also possible for other items equipped with transponders.

The communication occurs when at least two transponders are situated in the working zone of the field generator and are at a sufficiently small distance from one another. Both the position of the working zone and the size of this distance are jointly determined by signal strengths, the reception sensitivities, the interference conditions and in particular by the position of all antennae relative to one another and their antenna radiation geometry. A signal emitted by a transponder is received by one or more other transponders. It can be answered by signals in the opposite direction according to a defined protocol.

The solution proposed in principle permits all known, suitable transmission modes for the communication, including modes and protocols which are inherently intended for the terminal, transponder route.

The energy-supplying signal may be modulated by alternating load from the transponder. At the same time the clock pulse timing for the transponder can be obtained from the energy signal. Modulation is now performed with a subdivided clock pulse and therefore at maximum has a fraction of the clock frequency. This is conducive to the separability of a strong carrier and weakly received response modulation due to the large interval in the frequency range.

As with any type of data communication on the same transmission channel or medium, a communication structure that must initially be assumed to be random can give rise to conflicts, for example so-called collisions. In this case two (potential) parties to the communication simultaneously transmit uncoordinated data. The resulting superimposition prevents reception of the data.

This is usually remedied by timing corrections to the transmission attempts and synchronization or coordination by a so-called master. The invention in principle lends itself to the widely published conflict and collision resolution procedures known to those skilled in the art. Channel separation in the transmission through frequency management and spread spectrum modulation with different code sequences (CDMA) is also feasible.

In the case of contactless smart cards, the solutions according to the invention open up a number of new applications. For example, one smart card working as means of payment could make a payment directly to another card. For this purpose the parties to the transaction would have to operate a field generator situated on premises where payments are ordinarily transacted, say in cash desk or counter areas. It is possible to design the field generators in the form of trays or plate-shaped generators. Highly secure transaction protocols would have to be used for payment transactions in order to counter tampering and fraud.

The transfer of credit from payback or prepaid cards would be undertaken in a similar way. The credits might consist of discount or credit points, air miles or telephone units. The awkward use of cash, stamps or tallies, particularly where many constant small amounts are being paid or entered (admission charges, tickets, newspapers, coin vending machines, canteens, change machines, launderettes etc.) can be dispensed with through fixed value entry on or by smart cards.

In some of these payment transactions there is no need to use a conventional smart card terminal, a further card instead being advantageously used as the other party to the transaction. Using this card as second carrier of value transaction data is far less expensive solution. It is easy to carry, cheap to send, easy to store securely and easy to distribute locally to many cardholders.

The field generator does not have to be more heavily secured than its actual value warrants, since it contains no confidential data to be protected. The absence of any communications device means that it can be of more simple and less expensive design than a terminal. Any linking to a system, generally necessary in the case of terminals, is dispensed with.

The exchange of calling cards and business cards could be automated in that business associates could place their personal smart cards on a plate-shaped field generator, each card storing the data (addresses, personal and company details etc.) from the other card. These data can be used, for example, in databases on a personal computer, hand-held organizer or mobile phone.

The invention will permit mutual identification in security applications, police, factory security, offices, without a centralized gathering of information, which data protection law would regard as more questionable. From a security standpoint, smart card-to-smart card communication has the advantage that there is a strict separation of information that requires protection on the portable smart card from the energy supply that merits less protection and would be fixed and unguarded. Similarly, specially authorized persons might have inspection check stamps or seals in the form of a smart card. The invention allows this function to be transferred to other smart card holders for specific purposes or for defined periods of time.

A further application is the process of authorizing a smart card by assuming the authority vested in another smart card. In present-day systems a comparable action is generally linked to central systems. With the solution proposed this process can be decentralized at little cost. Such authority can likewise be granted for one single action only or a time restriction imposed.

A further application is a decentralized and explicit transfer of validity from a card expiring at the end of its period of validity to a new card. Under current procedures the periods of validity must overlap and the new, already valid cards must then be distributed in good time beforehand with all the attendant risk. Alternatively the cardholders can exchange the cards at central, trustworthy agencies or cardholders are visited to make the exchange. In the case of a direct communications facility the cardholder himself could transfer the validity at a field generator. The authorization is taken over from an expiring card, the rights of which will lapse upon successful transfer.

In some less sensitive cases this process may also be associated with the personalization of a card by the holder himself, for example the issuing of second cards and subordinate cards, the main card remaining valid.

The communication according to the invention represents an advantageous way of clearly transferring validity when returning, exchanging or altering tickets, travel or flight tickets, vouchers, goods and packagings that contain transponders.

In the same way as credits, cards that communicate directly with one another are capable of managing deposits for the hire of equipment or the use of cloakrooms, for example. A participating card can collect the deposits, for example, the customer card can pay and recover the deposits and a further card can return the deposits.

This is also advantageous in the case of shopping carts, if a transponder card (doubling, for example, as a customer card) is inserted instead of the coin deposit. A deposit-taking transponder is then incorporated in the cart. At the shopping cart collection points there are field generators, the function of which is linked to the release/return of carts or passage through a gateway. The cart itself may contain a field generator which, whilst shopping, for various purposes permits direct communication of the customer card or the cart transponder with other transponders on shelves or on the actual goods.

Price tags provided with transponders can match the discount information to the customer card or stocks of goods in the basket can be registered and entered. In these and similar applications, the low cost of installing the systems makes the solution outlined advantageous. The taking of deposits may be linked to reporting functions.

A further application is regulating the access to resources commonly available to multiple cardholders but only useable by each of them exclusively. The current right of access to be conferred only one at a time per resource can be managed by directly communicating cards. For each resource there is at any one time only one valid card from the number of cards belonging to a larger group of generally authorized cardholders. Access is regulated by the transfer of the code conferring exclusive right of access from a card of one cardholder to the card of another cardholder. At the same time the utilization data in the cards can be logged and relayed.

As an example, a pool of vehicles may be used by a larger group of drivers. Although each driver has a vehicle pool entitlement card, possibly with an individual identification, he would only have the right to use a maximum of one vehicle from the pool at a time. The driver has acquired this right locally from another driver and can likewise in turn pass it on. The related data for user accounting and settlement purposes can be relayed therewith.

In medical applications the transfer of local information in accordance with the invention is advantageous in order firstly to permit the known advantages of transponders and smart cards as data carriers and secondly to dispel the heightened sensitivity with regard to data protection in this sphere, especially in opposition to centralized system architectures.

Proof of identity in transponder form for blood donors and recipients and electronic labels on the units of stored blood with data logging but with without central databases, or in order to supplement the latter, are feasible. The labels and the proofs of identity could communicate with one another in the course of donation or transfusion.

The drugs prescription on a patient record can also be automatically compared with electronic packaging labels. This also makes errors, forgeries and negligence regarding drug incompatibilities more difficult perpetrate.

Data from radiation or chemical dosimeters with transponder interface can be transferred by direct transponder communication and collected very promptly—but non-centrally and by simple means.

Also feasible are transponder implants, which communicate directly with one another or directly with an external transponder when an alternating field is passed through the body. Chemical, mechanical, electronic or acceleration sensors (for blood sugar, bone forces, bioelectric voltages or movements, for example), mechanical, electrical or acoustic actuators (e.g. pace-makers or inner ear implants) or implanted drug release systems besides identification sensors can communicate directly. Recording instruments can also be connected on this principle.

The invention allows a system to be introduced in as much as the field generators do not have to be incorporated into the application. In contrast to conventional terminals they can be ready produced and installed independently of the application, and developed and standardized even before protocols and use of the respective smart card. New protocol versions or other application specifics can therefore be introduced simply by issuing the smart cards.

Widely differing card systems, protocols and applications of successive generations can coexist on the same infrastructure of largely universal field generators once the latter have been introduced. The only major prerequisite is the adherence to physical parameters in new smart cards, so that the energy supply remains assured (e.g. the frequency range).

The feasibility of universally maintained field generators imposes far fewer technical or organizational constraints on the development of new applications than in the case of conventional terminals, which in the event of a new application very often have to be re-incorporated into the system periphery.

With further regard to future developments, smart cards might not only transfer data to one another, but also programs or parts of programs on their controller chips. In this way new functions would be transferred, existing functions expanded or software versions updated virtually as a side effect of the ordinary use.

In the case of transponders incorporated into packaging, objects or workpieces, information can be relayed via a chain of transponders each communicating one with another. Transponders operating inside the chain in this case act like relays. Such a communications chain, for example, can compare the completeness or the expiring validity of the transponders in the chain with a stored default. Such a chain can be formed by the arrangement of packs or items with transponders in stacks and on shelves etc.

Using the communication from multiple transponders provides continual support for assembly and packing. In some cases an energy supply using multiple field generators is also advantageous. At the end of the chain data can be transmitted to a terminal in the conventional way.

Concatenated communication in just one dimension can, with the appropriate changes, be extended to two or three-dimensional arrangements. Fields or three-dimensional stacks or random heaps of items with transponders then each communicate with one another.

The concatenated communication from a line or two-dimensional arrangement, a stack or the like has a general technical advantage:

Only the necessary energy emission increases as a function of the maximum distance between transponder and field generator, in short the size of the stack. As idealized model, this dependency describes a cubic function. Inversely, it means that the minimum energy available on the transponders diminishes with the cube of the stack size. The necessary communications range, however, is determined only by the constant interval of the transponders in the chain. In the case of irregular intervals (e.g. heaps) the range is determined by the maximum interval occurring. The range is always independent of the stack size.

With conventional contactless transponders, as with conventional terminals individually scanning each transponder in the stack, the necessary communications range for the response back to the terminal is also to be designed to increase as a direct (idealized as a cubic) function of the stack size.

In this respect, for an identical reception sensitivity and the same difference between transmitter and receiver signal, with the method according to the invention the transponder function is capable of penetrating through a far larger stack than would be conventionally possible. The general advantage described can also be used to increase the functional reliability or for more cost-effective solutions with a smaller communications range. Moreover, there may also be advantages in terms of speed compared to conventional individual scanning.

A field generator may be of mobile design. It may, for example, be a small hand-held instrument. Such a mobile field generator may be led along a chain of transponders, for example, so that precisely every two or some specific number of adjoining transponders communicate with one another. Each transponder checks for the presence of another or verifies the suitable proximity thereof. Thus it is possible to check the completeness and/or the sequence of items in an arrangement.

The assembly, testing and servicing operations for complex installations can be supported by transponder identification and concatenated transponder communication thereof. Completeness and relative positions can be compared with planning data.

An advantageous application is the transmission of parameters from one specimen of a charge, production batch or lot to the other specimens. Thus the characteristics maps of sensors that have been created together with the transponders can be determined on one or a few specimens and transferred to the entire production batch. Safety features can be transmitted in a similar way. In the manufacture of semiconductors, transfer on the wafer from chip to chip prior to separation into individual chips may in some cases be advantageous. At the same time, in addition to parameters, it is also possible to determine, process pass on and/or enter test results or data personalizing each chip.

In one embodiment, particularly high-volume energy provisions are possible using multiple field generators. The effective communications ranges of the transponders may be purposely kept small in contrast to the extended range with adequate energy supply. For example, the frequently necessary activity consciously performed by the individual (the so-called “deliberate action”) may be defined as the direct placing of smart cards one on top of another. The location of this action within the extensive field is, however, not fixed.

So-called private principles for important, pecuniary, security or hazardous actions may require the presence of two authorized persons. Each of the persons has a separate smart card. The action is permitted only when both smart cards have been checked.

The two-card process cannot be introduced without modifying the transaction mechanism of the smart card systems introduced, which are based on only one card. The direct communication between the two smart cards according to the invention makes this possible. As hitherto, one or both smart cards in this case have the conventional function of the card system with one card. This card function, however, is only activated for a specific period of time by the direct communication with the second validated card. If contact-based card systems are expanded they also need a single field generator. This can sometimes be dispensed with if a transponder antenna can also be utilized to emit energy. Contactless card systems can also use the energy emitted by the conventional terminal.

In many of the applications the display and operating components of future generations of smart cards are of considerable advantage. The components will be used where one of the procedures according to the invention is to occur or has occurred.

Communications processes may be permitted by operating functions or equipped with parameters and/or values. In the same way directly communicated data can be read off by displays.

Times to be allowed for processing, handling or technical support can be entered from one transponder on to another by field generators with an impressed pattern of time signals. The time, location or identity of the field generator for the direct communication may at the same time be noted, e.g. patrol key for security guard.

In the case of sequences or security procedures in which seals, lead seals, stamps or badges are currently used, it is necessary to examine that they are intact and genuine. This often has to be done repeatedly at regular intervals. An inexpensive “seal” or “lead seal” transponder, which can be read off automatically and far more reliably to prevent counterfeiting is advantageous. The security data can be read off for inspection by direct communication or can be copied on to a logging transponder. The seal apparatus enters these data into the seal or the lead seal. Opening a seal or lead seal inevitably destroys the transponder.

As a further embodiment the lead seals may consist of two or more parts joined together. At least two parts of a “transponder lead seal” may each contain a transponder, the process of (lead) sealing by joining the parts together in such a way that they cannot can be detached without destroying them also being linked to the direct communication of the transponders. The transponders, once connected together by the direct communication during the act of sealing, then form a distinctly fixed pair (or group), which by virtue of their paired identity data is very difficult to falsify.

The number of direct communications during the service life or validity of a transponder may be preset in the circuit or the fixed programming. In the case of the “transponder lead seal”, it may be advisable to permit just one “pair-forming” direct communication for the sealing, and limited or any number of read-outs. The read-out process may be conventional, that is to say successively between each transponder and a terminal. Alternatively the read-out process may again use the direct communication according to the proposed solution at least in specific phases or during some sub-routines. All communications of the “seal” or “lead seal” transponders can be encrypted.

If at least one of the transponders is connected to a sensor, sensor data, including data from buffered log memory devices, can be communicated to the other transponder by direct communication.

Of great interest are solutions which as field generators do not use additional devices but make use of devices already in service and intended for other purposes, such as a mobile phone. The device is activated for emission, for example by a telephone call. This supplies the field energy required for the communication. The transponders can pick up the transmitted energy on the cellular radio frequency bands. They can then, however, also communicate on other frequency band in order to avoid conflicts. One example of many applications is the transmission of credit units remaining on a prepaid telephone card.

Other intentional and unintentional emissions of adequate field strength can also be used as field generators. Given appropriate safeguards against excessive field energy, even a microwave oven is feasible if the transponders can be supplied with energy in the order of a few GHz.

Such safeguards include overvoltage and overcurrent cut-outs, switchable attenuations and mismatches, screenings and/or cooling. This field generation is particularly advantageous in transponder applications in the context of products which are in any case prepared or processed in microwave ovens.

The dimensions and geometry of the transponder antennae generally make them well suited to emitting the energy-supplying alternating field, which they normally pick up.

Many devices and data carriers with transponders in any case have contacts or connections or can readily be equipped therewith. As an example of such a data carrier, mention will be made of the dual-interface card, a smart card in widespread circulation both with contact field and also with contactless interface. In a plug-in device electrical energy can now be fed into the unit or the data carrier via the contacts. It can be fed either directly as an a.c. voltage, reaching the transponder antenna directly, or the d.c. or mains a.c. voltage supplied may alternatively be suitably converted for emission by an a.c. voltage generator on the data carrier.

The cost of installing a field generator on the plug-in device can thereby be reduced still further. An ordinary card reader which does not shield parts of the card and delivers voltage can, together with such a card, form a field generator.

A coil having a transformer core opened in the magnetic flux can be produced as a very simple field generator with largely inductive field energy. A prerequisite for this is that suitable transponders are capable of operating in these usually low frequency ranges (16-400 Hz).

The invention will be further described with reference to examples of embodiments shown in the drawings to which, however, the invention is not restricted.

In the drawings:

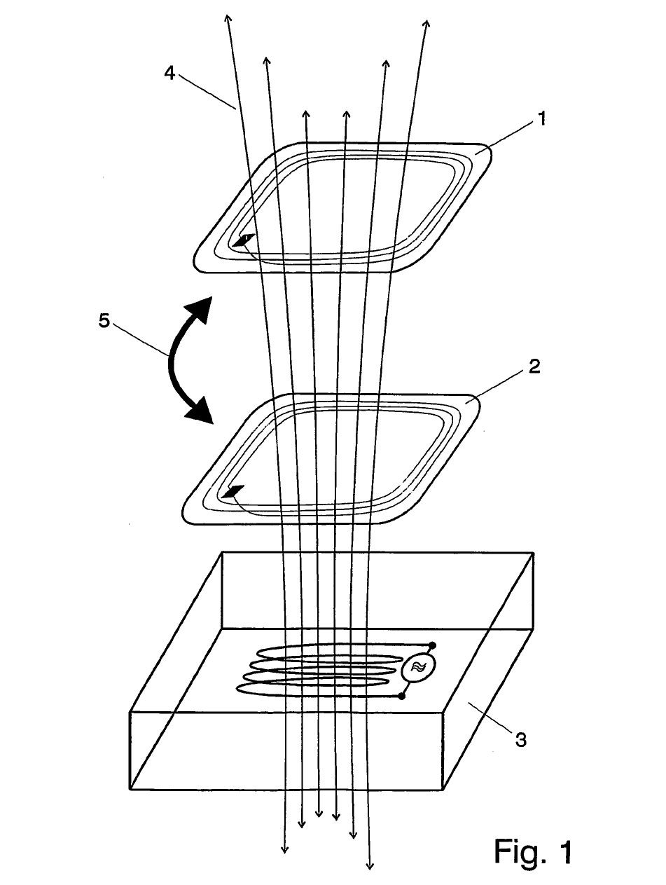

FIG. 1 shows the application of the invention with two smart cards and one field generator;

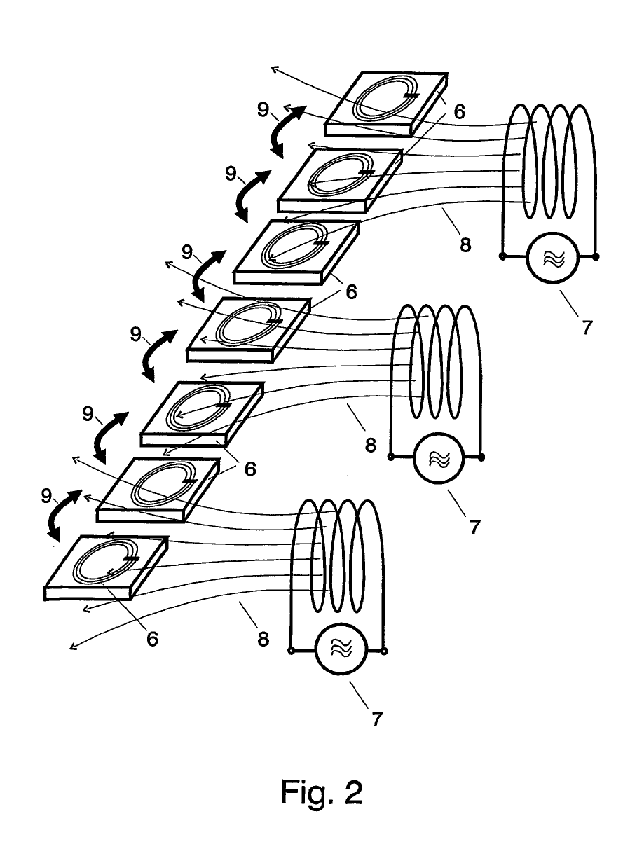

FIG. 2 shows the interaction of multiple field generators and transponders;

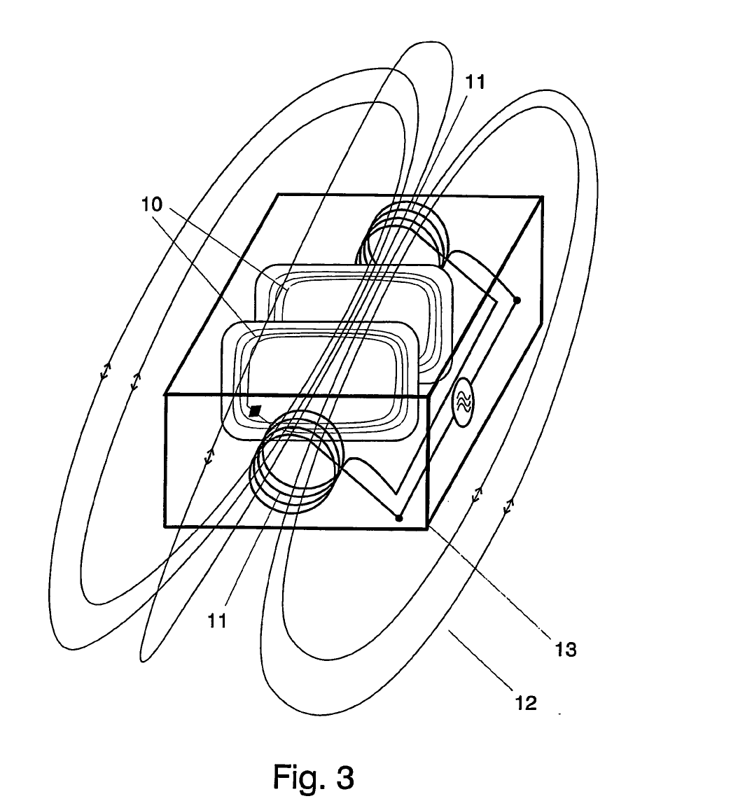

FIG. 3 shows the communication of two smart cards in a spatially enclosed field generator;

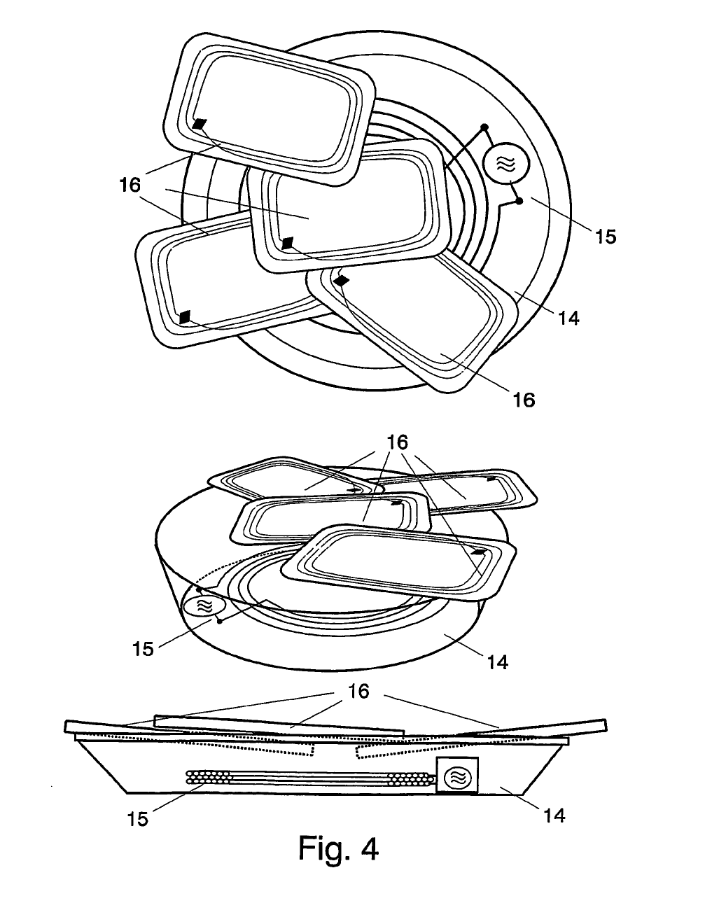

FIG. 4 shows the communication of multiple smart cards on a plate-shaped field generator;

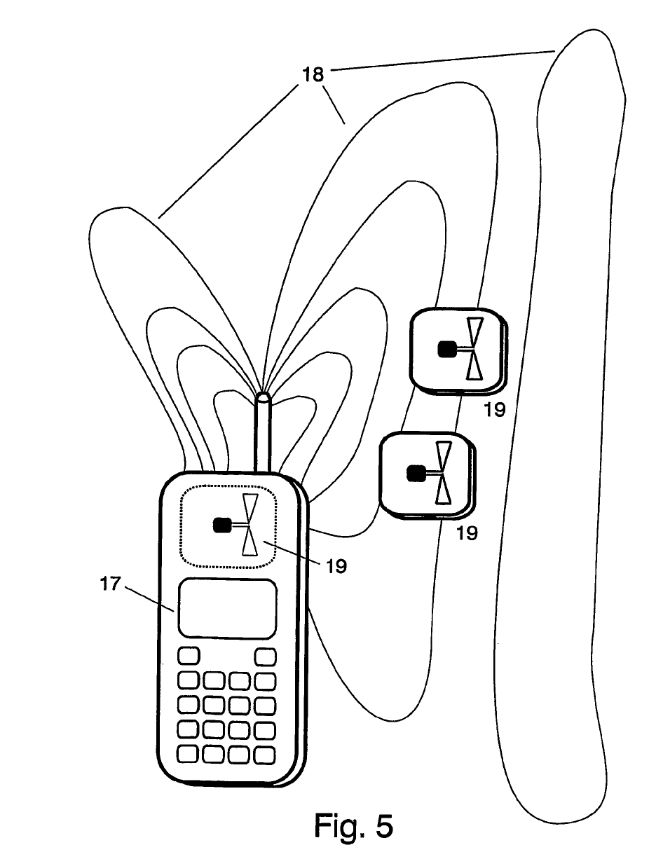

FIG. 5 shows the use of a mobile phone as field generator;

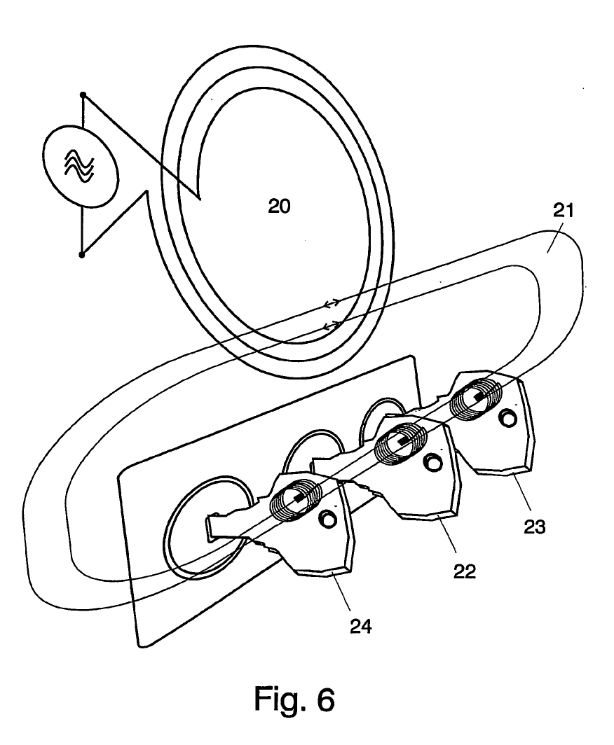

FIG. 6 shows the invention applied to the non-central personalization of transponders, using the copying of transponders in car keys as an example;

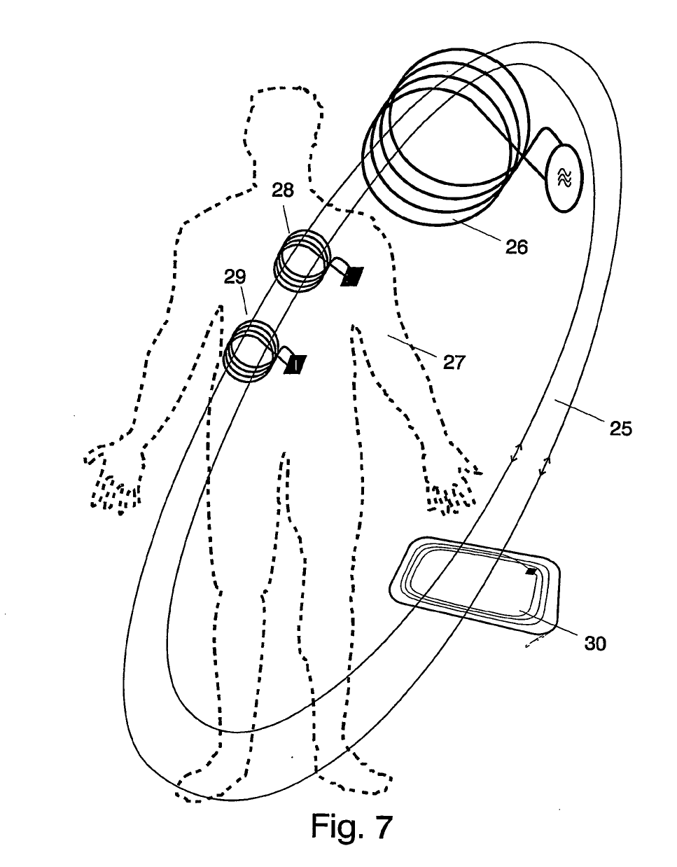

FIG. 7 shows a medical application of the invention;

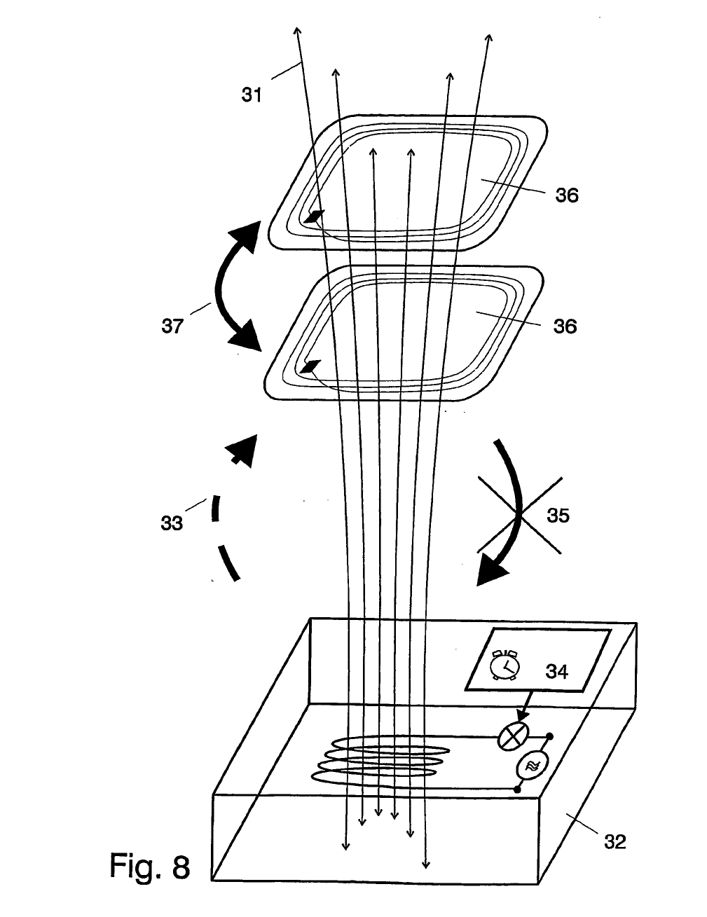

FIG. 8 shows an extension of the invention; and

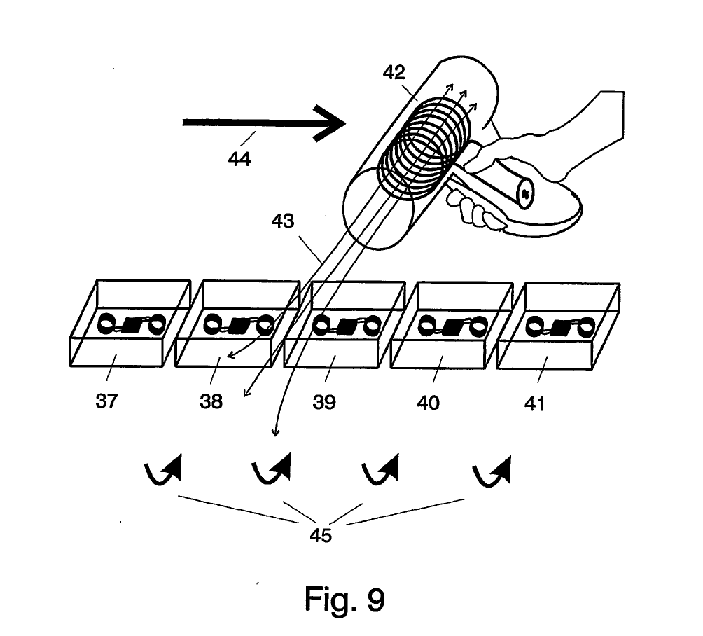

FIG. 9 shows an example of an embodiment having one fixed field generator.

FIG. 1 serves to illustrate the invention. Two contactless smart cards 1 and 2 are situated above a field generator 3, which is here represented schematically as transmitting coil and high-frequency alternating current generator.

The alternating field 4 emitted passes through the smart cards 1 and 2. This field is supplied by the field generator 3. In the example of an embodiment the field generator does not have any data processing components. The data exchange 5 occurs exclusively and directly between the contactless smart cards, that is without the data-transmitting, data-receiving or data-storing involvement of the field generator 3.

FIG. 2 illustrates the interaction for an example with multiple field generators and transponders. Numerous transponders 6 are situated in a specific, extended spatial arrangement, one in each packing unit, workpiece or the like. The arrangement shown might be made up, for example, of cuboid units on a conveyor belt or a pallet.

Multiple field generators 7 emit alternating fields 8, which each supply some of the transponders 6. Each transponder can communicate with its immediate or more remote neighbors, as is indicated by double arrows 9. This can be used for independent communication over large spatial areas.

Information can also be passed on in stages, however. For example, the identity of all parties to the communication can be relayed so that completeness information is available on each party. At the end or at any transponder in such a chain, conventional communication with a terminal (not shown) may be employed. Alternatively one transponder can be attached solely for the purpose of data transport or can be taken out of the chain.

FIG. 3 shows an example of the communication between smart cards, which have been plugged in or inserted in an enclosed field generator 13. The figure shows two contactless smart cards 10, which are introduced into a housing in which a field generator 11, here having two transmitter antennae, generates the energy-supplying alternating field 12. For example, the cards which are intended to communicate may be introduced into the housing through suitable insertion slots. However, a special card (e.g. a dealer, supervisor or master card) may be inserted into the housing for a period of use or a specific purpose.

The field generator in the housing can thereby be made and marketed as a multipurpose device, but dedicated to one purpose by the card inserted. The card inserted can also log transactions or store amounts. A deliberate action would have to be defined on introduction into the housing.

FIG. 4 shows a plate-shaped field generator on which smart cards lie. In this case a housing 14 resembling a plate, a tray or a dish is used, the material of which allows the electromagnetic field to pass through largely unaffected. In the housing is the field generator 15 with the transmitter antenna or coil. Smart cards 16, transponders or appliances or packagings with transponders can be laid on the top of the housing. The field passes through them and they begin to communicate with one another.

This design may serve, for example, in the case of electronic visiting or business cards for communicating details of the parties to a discussion. Its simplicity of construction and its uncomplicated handling make this embodiment advantageous for other applications already outlined.

As an example of an embodiment using an appliance inherently designed for other purposes as field generator, FIG. 5 shows a mobile telephone 17, which emits an alternating electromagnetic field 18. Multiple transponder components 19, for example minicards for mobile phone payment, are situated in the field of adequate strength and in communications range. For the purpose of the invention it is of no consequence whether this acts inside or outside the mobile phone casing. There must, however, be no shielding of the field.

One possible application is the relaying of identities, telephone data, credits or messages stored non-centrally and in personalized form on the transponder units. The transponder system, especially the antenna designs, must be adjusted to the frequency ranges of the mobile phones (e.g. 900, 1800 or 2400 MHz).

The information content of the telephone transmissions is of no significance for the application; what is being used here is the energy of the high-frequency field, i.e. of the carrier, for example. The transponders must tolerate influences and fluctuations due to modulation and frequency management of the mobile phone system. Where necessary an emission at maximum transmission output is to be induced. This can also be provided as a special operating function of the telephone.

FIG. 6 represents a device for copying car keys equipped with transponders. A field generator 20 supplies an alternating field 21, which passes through multiple keys 22, 23, 24 in a mechanical holding device. The key grips contain transponders, which in the alternating field enter into direct communication with one another. This communication gives rise to direct “conformity” of the authorized transponders through direct data transfer. This data transfer may be protected by encrypting measures.

Such a simple device which need not have any information relevant to safety/security and is very cost effective to produce and to distribute, can be available at garages and key cutting services. An organized data management is not necessary, the operation is trivial. Protective measures are not necessary. The unit may be readily bought.

From an already personalized transponder (e.g. 24) it is now possible by inserting a second non-personalized transponder (e.g. 23) to produce a copy through direct communication of the transponders. In so doing the data are transferred securely from one key to the other. The second key is either not yet or no longer personalized. The already personalized key corresponds to the master key, the other to a key blank, as in the case of mechanical copying of keys.

In addition a special key (e.g. 22) may exist, which comes into contact with the personalization sequence in that it comes into communication with the key to be copied and also with the non-personalized “blank”. The special key may in the figurative sense fulfill the functions of a notary public. A copy may be furnished with restrictive features. For example, a time limit may also be set in the case of company and hire cars or in the case of temporary overfill in garages, hotel parking bays etc. Provisions can moreover be made to prevent further copies being made of such a restricted privileges card. A special key can serve to implement these restrictions.

In another device of the same type the insertion of another special key may serve to cancel entitlements, which is useful for a code change in car sales. In another embodiment the special key may have input elements. It may be distributed for increased security in a way that is specially traceable. Its validity may be restricted by setting time limits or a limit on the number of copies. It can record the code numbers of the keys for which it allowed copying. It is thereby possible to identify any misuse. It is also possible to enter on the copies or the original key whether, when and by means of which special key copies were made.

This example can be transferred, subject to the necessary changes, to many similar applications. The advantages compared to a transponder terminal lie in particular in the construction of the field generator without data processing or system links and in the greatly reduced costs of administration and safeguards.

In the example of an embodiment according to FIG. 7 the energy-supplying alternating field 25 is generated by a field generator 26. It passes through the body tissue 27 and an area surrounding the body. Two implants 28, 29, which contain transponders, communicate directly with one another. Data can similarly be transferred between implanted transponders 28, 29 and transponders 30 situated outside the body. For example, sensor data could be transmitted. The programming of parameters for active implants would also be possible by direct communication. Implants could record data at various times and relay them to other transponders according to the proposed solution.

An implanted transponder may be used for the output of identification codes or personal characteristics secure from error. A second external transponder on a patient record or a pharmaceutical packaging, for example, can for this purpose communicate directly with the implant.

FIG. 8 represents an example of an embodiment in which the energy-supplying alternating field 31 is generated by a field generator 32, which in addition to the field energy emits single signals, pulses or characteristic data. The generation of these signals requires little if any costly system integration, for example a single setting at the time of installation or maintenance.

The signals may be alert, clock or synchronization signals. Time marks, location identifications or unit identification codes and the like may likewise be inserted. A sensor value or status information for temperature, pressure or smoke emission or “defect”, “accident” or “alarm” conditions, for example, can be delivered to the communicating data carriers. In this example of an embodiment the field generator does not receive any data from the transponders, which is symbolized by the arrow 35 which has been crossed through.

FIG. 9 represents an example of an embodiment with a moveable field generator 42, which is designed as a small, mobile hand-held unit. The energy-supplying alternating field 43 only passes through a smaller spatial area so that from a voluminous arrangement of numerous transponders 37 to 41 only a small proportion 38 and 39 thereof are communicating at any one time.

These transponders are here shown in schematic form inside objects (workpieces, packagings, assembly parts, pipes, means of transport, vehicles or the like), which in each case have an antenna coil at ends or sides facing one another. The alternating field 43 is sufficient to supply precisely one contact or proximity point of two items. At this point the data to be transmitted are relayed. If the field generator 42 is brought along the items in a direction of movement 44, information can be transferred from item to item 45 in stages. In addition, information could also be obtained on spatial proximity relationships using the identification of the particular transponders communicating with one another.

Completeness markings, fault conditions, validities, batch numbers, sensor data and the like can be relayed in this way, in the same way that it is possible to check the spatial arrangement of items in relation to one another or information on their order sequence. This principle can be used in the checking, counting and further processing of transponders. Suitable spatial arrangements often exist anyway (semiconductor wafers, smart card laminate films as sheets, banknotes in each case with transponder marking). Movement of the field generator may be replaced by the movement of the items with transponders, for example on conveyor belts, regular timetable road vehicles, lifts, in moving containers or in material reels (reel-to-reel production) and in pipelines.

1. A method for the communication of microelectronically integrated data carriers which contain contactless communications devices, characterized in that
at least two of the data carriers are brought into the reciprocal range of their contactless communications devices;
at least one component generates an alternating electromagnetic field so that the data carriers are supplied with sufficient energy for the internal processing and communications operations; and
data can be transmitted directly from at least one of the data carriers to at least one other data carrier.

2. A method as claimed in claim 1, characterized in that the field-generating component receives no data from the data carriers.

3. A method as claimed in claim 1, characterized in that for the start of communication the field generator sends information on the type of communication.

4. A method as claimed in claim 1, characterized in that the data carriers are energized for the start of reciprocal communication by the availability of energy from the alternating field.

5. A method as claimed in claim 1, characterized in that the space occupied by the energy-supplying alternating field and/or the communications range is defined by mechanical measures, so that only a specific number of data carriers can participate in the communication.

6. A method as claimed in claim 1, characterized in that at least some of the data of at least one data carrier are copied to at least one other data carrier.

7. A method as claimed in claim 6, characterized in that
at least one data carrier is a transponder key for an object (vehicle, premises, site, machine, computer, locker, etc.); and
the direct communication is used for the copying of the transponder key.

8. A method as claimed in claim 7, characterized in that up to one specific whole number (between zero and a large finite number) of copies can be made in this way.

9. A method as claimed in claim 6, characterized in that from a copy of a data carrier compiled by direct communication only a specific whole number (between zero and a large finite number) of new copies can be made in this way.

10. A method as claimed in claim 6, characterized in that the number of copies still permitted diminishes with each copying process.

11. A method as claimed in claim 6, characterized in that a copy compiled by direct communication has a limited functioning period.

12. A method as claimed in claim 6, characterized in that a copy compiled by direct communication has a functioning period limited to a pre-determinable scale of use of the data carrier.

13. A method as claimed in claim 1, characterized in that:
the data carriers are parts of a lead seal; and
the lead seals and/or the checking of a lead seal is linked to an exchange of data by direct communication.

14. A method as claimed in claim 1, characterized in that in addition to the energy of the alternating field, the field generator emits additional information, which is stored in at least one of the data carriers in order to document the communication.

15. A method as claimed in claim 1, characterized in that in addition to the energy of the alternating field, the field generator also emits alert pulses for the data carrier.

16. A method as claimed in claim 1, characterized in that if more than one field generators are used, alternating fields are generated for supplying data carriers in a spatially extended area.

17. A method as claimed in claim 1, characterized in that the communication takes place over multiple data carriers, the adjacent data carriers in each case communicating directly with one another.

18. A method as claimed in claim 1, characterized in that the presence of each data carrier participating in the communication is marked in the data transferred.

19. A method as claimed in claim 1, characterized in that in addition to a phase of direct communication of the data carriers, a further phase of the communication occurs between at least one of the data carriers and the field-generating component, in which the field-generating component participates in the communication as a transponder terminal.

20. A method as claimed in claim 1, characterized in that:
the field-generating component is part of a moveable unit; and
the said unit identifies the transponder antennae, the transponders of which are intended to communicate with one another, so that only these transponders are supplied with the alternating field.

21. A device for the communication of microelectronically integrated data carriers, which have contactless communications devices, characterized in that:
at least two of the data carriers having contactless communications devices are in a reciprocal communications range;
at least one component is available for the generation of an alternating electromagnetic field, which supplies the data carriers with energy for processing and communications operations; and
this field spans a sufficient spatial area of adequate field strength, in which the data carriers can be supplied for the direct communication.

22. A device as claimed in claim 21, characterized in that the field-generating component does not have any data-transmitting or receiving devices for communication with the data carriers.

23. A device as claimed in claim 21, characterized in that at least one of the data carriers receives data from at least one sensor, the measured data from which can be delivered to at least one other of the data carriers by direct communication.

24. A device as claimed in claim 21, characterized in that at least one of the communicating data carriers is part of a body implant.

25. A device as claimed in claim 1, characterized in that at least two of the communicating data carriers at the time of the communication are part of the same semimanufactured product (semiconductor wafer, laminate sheet, material carrier reel, etc.)

26. A device as claimed in claim 21, characterized in that the field-generating component is a device which is inherently designed for a purpose other than the direct communication of the data carriers.

27. A device as claimed in claim 26, characterized in that the field-generating component is a conventional transponder terminal, the alternating field emitted by which supplies the energy for the direct communication of the data carriers, but no data from the direct communication of the data carriers are registered in the terminal.

28. A device as claimed in claim 26, characterized in that the field-generating component is the transmitter device of a mobile telephone.

29. A device as claimed in claim 26, characterized in that the field-generating component is the transmitter device of a microwave oven.
